(19) United States
(12) Patent Application Publication
(10) Pub. No.: US 2017/0025063 A1
(43) Pub. Date: Jan. 26, 2017

(54) SYSTEMS AND METHODS OF HYBRID CALIBRATION OF BIAS CURRENT

(71) Applicant: Ignis Innovation Inc., Waterloo (CA)

(72) Inventor: Gholamreza Chaji, Waterloo (CA)

(21) Appl. No.: 15/215,036

(22) Filed: Jul. 20, 2016

(30) Foreign Application Priority Data
Jul. 24, 2015 (CA) 2898282

(51) Int. Cl. G09G 3/3233

(52) U.S. Cl. CPC G09G 3/3233; G09G 2300/0819; G09G 2320/045; G09G 2300/0842

(57) ABSTRACT

What is disclosed are systems and methods of compensation of images produced by active matrix light emitting diode device (AMOLED) and other emissive displays. Anomalies in bias currents produced by current biasing circuits for driving current biased voltage programmed pixels are corrected through calibration and compensation while re-using existing data or other lines that can be controlled individually to perform said calibration and compensation.

### PRIORITY CLAIM

This application claims priority to Canadian Application No. 2,898,282, filed Jul. 24, 2015, which is hereby incorporated by reference herein in its entirety.

### FIELD OF THE INVENTION

The present disclosure relates to current biasing for pixels of light emissive visual display technology, and particularly to systems and methods for programming and calibrating pixel current biasing in active matrix light emitting diode device (AMOLED) and other emissive displays.

### BRIEF SUMMARY

According to a first aspect there is provided a system for providing biasing currents to pixels of an emissive display system, each pixel having a light-emitting device, the system comprising: a plurality of current biasing elements; a plurality of current bias lines coupling said plurality of current biasing elements to said pixels; and a controller coupled to said current biasing elements for controlling a programming of said current biasing elements over a plurality of signal lines; wherein each current biasing element comprises: at least one current driving transistor coupled to a current bias line for providing a biasing current over the current bias line; and a storage capacitance for being programmed and for setting a magnitude of the biasing current provided by the at least one current driving transistor; wherein the controller's controlling the programming of each current biasing element comprises: during a programming cycle charging the storage capacitance to a defined level; and subsequent to the programming cycle, during a calibration cycle, partially discharging the storage capacitance as a function of characteristics of the at least one driving transistor.

In some embodiments, the plurality of signal lines comprises a plurality of data lines coupling a source driver of the emissive display system to the pixels and for programming said pixels, the data lines for coupling the controller and the plurality of current biasing elements at times different from when the data lines couple the source driver to the pixels.

Some embodiments further provide for a reference monitor line shared by the plurality of current biasing elements and coupling the plurality of current biasing elements to the controller.

In some embodiments, each current biasing element is a current sink, wherein the at least one current driving transistor comprises a single current driving transistor, wherein the storage capacitance is coupled across a gate of said current driving transistor and one of a source and drain of said current driving transistor, the other of said source and drain of said current driving transistor coupled to a voltage supply, wherein during the calibration cycle, the current driving transistor is allowed to partially discharge said storage capacitance through the current driving transistor to said voltage supply.

In some embodiments, each current biasing element is a current source, wherein the at least one current driving transistor comprises a single current driving transistor, wherein the storage capacitance is coupled across a gate of said current driving transistor and one of a source and drain of said current driving transistor, the one of said source and drain of said current driving transistor coupled to a voltage supply, wherein during the calibration cycle, the current driving transistor is allowed to partially discharge said storage capacitance through the current driving transistor to said voltage supply.

According to another aspect there is provided a system for providing biasing currents to pixels of an emissive display system, each pixel having a light-emitting device, the system comprising: a plurality of current biasing elements; a plurality of current bias lines coupling said plurality of current biasing elements to said pixels; a controller coupled to said current biasing elements for controlling a programming of said current biasing elements over a plurality of signal lines; and a monitor coupled to the plurality of current biasing elements for monitoring a biasing current produced by each current biasing element and for storing in a memory a measurement representing said biasing current for each current biasing element; wherein each current biasing element comprises: at least one current driving transistor coupled to a current bias line for providing a biasing current over the current bias line; and a storage capacitance for being programmed and for setting a magnitude of the biasing current provided by the at least one current driving transistor; wherein the controller's controlling the programming of each current biasing element comprises: retrieving from said memory said measurement representing said biasing current for the current biasing element; determining a deviation of said biasing current represented by said measurement from an expected biasing current; and charging the storage capacitance to a defined compensated level which compensates for said deviation so that said current biasing element produces the expected biasing current.

Some embodiments further provide for a reference monitor line shared by the plurality of current biasing elements and coupling the plurality of current biasing elements to the controller, the controller coupled to the monitor.

According to another aspect, there is provided a method of providing biasing currents to pixels of an emissive display system, each pixel having a light-emitting device, the emissive display system including a plurality of current biasing elements and a plurality of current bias lines coupling said plurality of current biasing elements to said pixels, each current biasing element including at least one current driving transistor coupled to a current bias line for providing a biasing current over the current bias line and a storage capacitance for being programmed and for setting a magnitude of the biasing current provided by the at least one current driving transistor, the method comprising: programming each current biasing element over a plurality of signal lines comprising: charging the storage capacitance to a defined level during a programming cycle; and subsequent to the programming cycle, during a calibration cycle, partially discharging the storage capacitance as a function of characteristics of the at least one driving transistor.

In some embodiments, the plurality of signal lines comprises a plurality of data lines coupling a source driver of the emissive display system to the pixels and for programming said pixels, the data lines for coupling the controller and the plurality of current biasing elements for performing said programming each current biasing element at times different from when the data lines couple the source driver to the pixels.

In some embodiments, a reference monitor line is shared by the plurality of current biasing elements and wherein said charging said storage capacitance comprises coupling to the controller over said reference monitor line each current biasing element being charged while de-coupling from the controller current biasing elements not being charged.

In some embodiments, each current biasing element is a current sink, wherein the at least one current driving transistor comprises a single current driving transistor, wherein the storage capacitance is coupled across a gate of said current driving transistor and one of a source and drain of said current driving transistor, the other of said source and drain of said current driving transistor coupled to a voltage supply, wherein during the calibration cycle, partially discharging the storage capacitance comprises allowing the current driving transistor to partially discharge said storage capacitance through the current driving transistor to said voltage supply.

In some embodiments, each current biasing element is a current source, wherein the at least one current driving transistor comprises a single current driving transistor, wherein the storage capacitance is coupled across a gate of said current driving transistor and one of a source and drain of said current driving transistor, the one of said source and drain of said current driving transistor coupled to a voltage supply, wherein during the calibration cycle, partially discharging the storage capacitance comprises allowing the current driving transistor to partially discharge said storage capacitance through the current driving transistor to said voltage supply.

According to another aspect there is provided a method of providing biasing currents to pixels of an emissive display system, each pixel having a light-emitting device, the emissive display system including a plurality of current biasing elements, a plurality of current bias lines coupling said plurality of current biasing elements to said pixels, each current biasing element including at least one current driving transistor coupled to a current bias line for providing a biasing current over the current bias line and a storage capacitance for being programmed and for setting a magnitude of the biasing current provided by the at least one current driving transistor, the method comprising: monitoring a biasing current produced by each current biasing element; storing in a memory a measurement representing said biasing current for each current biasing element; and programming each current biasing element over a plurality of signal lines comprising: retrieving from said memory said measurement representing said biasing current for the current biasing element; determining a deviation of said biasing current represented by said measurement from an expected biasing current; and charging the storage capacitance to a defined compensated level which compensates for said deviation so that said current biasing element produces the expected biasing current.

In some embodiments, the controller is coupled to the monitor, a reference monitor line is shared by the plurality of current biasing elements and wherein said monitoring each current biasing element comprises coupling to the controller over the reference monitor line each current biasing element being measured while de-coupling from the controller current biasing elements not being measured.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 illustrates an example display system utilizing the methods and comprising the current biasing elements disclosed;

FIG. 2 is a circuit diagram of a current sink according to one embodiment;

FIG. 3 is a timing diagram of current sink and source programming and calibration according to one embodiment; and

FIG. 4 is a circuit diagram of a current source according to a further embodiment.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

Many modern display technologies suffer from defects, variations, and non-uniformities, from the moment of fabrication, and can suffer further from aging and deterioration over the operational lifetime of the display, which result in the production of images which deviate from those which are intended. Methods of image calibration and compensation are used to correct for those defects in order to produce images which are more accurate, uniform, or otherwise more closely reproduces the image represented by the image data. Some displays utilize a current-bias voltage-programming driving scheme, each of its pixels being a current-biased voltage-programmed (CBVP) pixel. In such displays a further requirement for producing and maintaining accurate image reproduction is that the current biasing elements, that is the current sources or sinks, which provide current biasing provide the appropriate level of current biasing to those pixels. Due to unavoidable variations in fabrication and variations in degradation through use, a number of current biasing elements provided for a display, although designed to be uniformly and exactly alike and programmed to provide the desired current biasing level, in fact exhibit deviations in current biasing provided. In order to correct for visual defects that would otherwise arise from the non-uniformity and inaccuracies of these current sources or sinks, the programming of the current biasing elements is augmented with calibration and optionally monitoring and compensation.

As the resolution of an array semiconductor device increases, the number of lines and elements required to drive, calibrate, and/or monitor the array increases dramatically. This can result in higher power consumption, higher manufacturing costs, and a larger physical foot print. In the case of a CBVP pixel display, providing circuitry to program, calibrate, and monitor current sources or sinks can increase cost and complexity of integration as the number of rows or columns increases.

The systems and methods disclosed below address these issues through control and calibration of a family of current biasing elements while utilizing circuits which are integrated on the display in a manner which use existing display components.

While the embodiments described herein will be in the context of AMOLED displays it should be understood that the systems and methods described herein are applicable to any other display comprising pixels which might utilize current biasing, including but not limited to light emitting diode displays (LED), electroluminescent displays (ELD), organic light emitting diode displays (OLED), plasma display panels (PSP), among other displays.

It should be understood that the embodiments described herein pertain to systems and methods of calibration and compensation and do not limit the display technology underlying their operation and the operation of the displays in which they are implemented. The systems and methods described herein are applicable to any number of various types and implementations of various visual display technologies.

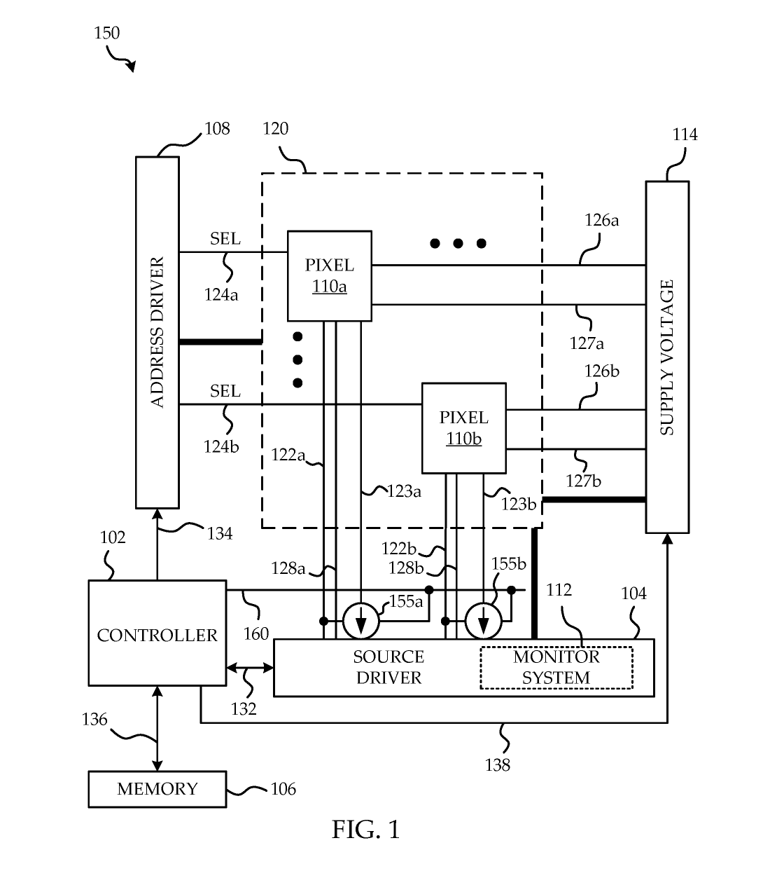

FIG. 1 is a diagram of an example display system 150 implementing the methods and comprising the circuits described further below. The display system 150 includes a display panel 120, an address driver 108, a source driver 104, a controller 102, and a memory storage 106.

The display panel 120 includes an array of pixels 110a 110b (only two explicitly shown) arranged in rows and columns. Each of the pixels 110a 110b is individually programmable to emit light with individually programmable luminance values and is a current biased voltage programmed pixel (CBVP). The controller 102 receives digital data indicative of information to be displayed on the display panel 120. The controller 102 sends signals 132 to the source driver 104 and scheduling signals 134 to the address driver 108 to drive the pixels 110 in the display panel 120 to display the information indicated. The plurality of pixels 110 of the display panel 120 thus comprise a display array or display screen adapted to dynamically display information according to the input digital data received by the controller 102. The display screen can display images and streams of video information from data received by the controller 102. The supply voltage 114 provides a constant power voltage or can serve as an adjustable voltage supply that is controlled by signals from the controller 102. The display system 150 incorporates features from current biasing elements 155a, 155b, either current sources or sinks (current sinks are shown) to provide biasing currents to the pixels 110a 110b in the display panel 120 to thereby decrease programming time for the pixels 110. Although shown separately from the source driver 104, current biasing elements 155a, 155b may form part of the source driver 104 or may be integrated as separate elements. It is to be understood that the current biasing elements 155a, 155b used to provide current biasing to the pixels may be current sources rather than current sinks depicted in FIG. 1.

For illustrative purposes, only two pixels 110a, 110b are explicitly shown in the display system 150 in FIG. 1. It is understood that the display system 150 is implemented with a display screen that includes an array of pixels, such as the pixels 110a, 110b, and that the display screen is not limited to a particular number of rows and columns of pixels. For example, the display system 150 can be implemented with a display screen with a number of rows and columns of pixels commonly available in displays for mobile devices, monitor-based devices, and/or projection-devices. In a multichannel or color display, a number of different types of pixels, each responsible for reproducing color of a particular channel or color such as red, green, or blue, will be present in the display. Pixels of this kind may also be referred to as “subpixels” as a group of them collectively provide a desired color at a particular row and column of the display, which group of subpixels may collectively also be referred to as a “pixel”.

Each pixel 110a, 110b is operated by a driving circuit or pixel circuit that generally includes a driving transistor and a light emitting device. Hereinafter the pixel 110a, 110b may refer to the pixel circuit. The light emitting device can optionally be an organic light emitting diode, but implementations of the present disclosure apply to pixel circuits having other electroluminescence devices, including current-driven light emitting devices and those listed above. The driving transistor in the pixel 110a, 110b can optionally be an n-type or p-type amorphous silicon thin-film transistor, but implementations of the present disclosure are not limited to pixel circuits having a particular polarity of transistor or only to pixel circuits having thin-film transistors. The pixel circuit 110a, 110b can also include a storage capacitor for storing programming information and allowing the pixel circuit 110 to drive the light emitting device after being addressed. Thus, the display panel 120 can be an active matrix display array.

As illustrated in FIG. 1, each of the pixels 110a, 110b in the display panel 120 are coupled to a respective select line 124a, 124b, a respective supply line 126a, 126b, a respective data line 122a, 122b, a respective current bias line 123a, 123b, and a respective monitor line 128a, 128b. A read line may also be included for controlling connections to the monitor line. In one implementation, the supply voltage 114 can also provide a second supply line to each pixel 110a, 110b. For example, each pixel can be coupled to a first supply line 126a, 126b charged with Vdd and a second supply line 127a, 127b coupled with Vss, and the pixel circuits 110a, 110b can be situated between the first and second supply lines to facilitate driving current between the two supply lines during an emission phase of the pixel circuit. It is to be understood that each of the pixels 110 in the pixel array of the display 120 is coupled to appropriate select lines, supply lines, data lines, and monitor lines. It is noted that aspects of the present disclosure apply to pixels having additional connections, such as connections to additional select lines, and to pixels having fewer connections, and pixels sharing various connections.

With reference to the pixel 110a of the display panel 120, the select line 124a is provided by the address driver 108, and can be utilized to enable, for example, a programming operation of the pixel 110a by activating a switch or transistor to allow the data line 122a to program the pixel 110a. The data line 122a conveys programming information from the source driver 104 to the pixel 110a. For example, the data line 122a can be utilized to apply a programming voltage or a programming current to the pixel 110a in order to program the pixel 110a to emit a desired amount of luminance. The programming voltage (or programming current) supplied by the source driver 104 via the data line 122a is a voltage (or current) appropriate to cause the pixel 110a to emit light with a desired amount of luminance according to the digital data received by the controller 102. The programming voltage (or programming current) can be applied to the pixel 110a during a programming operation of the pixel 110a so as to charge a storage device within the pixel 110a, such as a storage capacitor, thereby enabling the pixel 110a to emit light with the desired amount of luminance during an emission operation following the programming operation. For example, the storage device in the pixel 110a can be charged during a programming operation to apply a voltage to one or more of a gate or a source terminal of the driving transistor during the emission operation, thereby causing the driving transistor to convey the driving current through the light emitting device according to the voltage stored on the storage device. Current biasing element 155a provides a biasing current to the pixel 110a over the current bias line 123a in the display panel 120 to thereby decrease programming time for the pixel 110a. The current biasing element 155a is also coupled to the data line 122a and uses the data line 122a to program its current output when not in use to program the pixels, as described hereinbelow. In some embodiments, the current biasing elements 155a, 155b are also coupled to a reference/monitor line 160 which is coupled to the controller 102, for monitoring and controlling of the current biasing elements 155a, 155b.

Generally, in the pixel 110a, the driving current that is conveyed through the light emitting device by the driving transistor during the emission operation of the pixel 110a is a current that is supplied by the first supply line 126a and is drained to a second supply line 127a. The first supply line 126a and the second supply line 127a are coupled to the voltage supply 114. The first supply line 126a can provide a positive supply voltage (e.g., the voltage commonly referred to in circuit design as “Vdd”) and the second supply line 127a can provide a negative supply voltage (e.g., the voltage commonly referred to in circuit design as “Vss”). Implementations of the present disclosure can be realized where one or the other of the supply lines (e.g., the supply line 127a) is fixed at a ground voltage or at another reference voltage.

The display system 150 also includes a monitoring system 112. With reference again to the pixel 110a of the display panel 120, the monitor line 128a connects the pixel 110a to the monitoring system 112. The monitoring system 112 can be integrated with the source driver 104, or can be a separate stand-alone system. In particular, the monitoring system 112 can optionally be implemented by monitoring the current and/or voltage of the data line 122a during a monitoring operation of the pixel 110a, and the monitor line 128a can be entirely omitted. The monitor line 128a allows the monitoring system 112 to measure a current or voltage associated with the pixel 110a and thereby extract information indicative of a degradation or aging of the pixel 110a or indicative of a temperature of the pixel 110a. In some embodiments, display panel 120 includes temperature sensing circuitry devoted to sensing temperature implemented in the pixels 110a, while in other embodiments, the pixels 110a comprise circuitry which participates in both sensing temperature and driving the pixels. For example, the monitoring system 112 can extract, via the monitor line 128a, a current flowing through the driving transistor within the pixel 110a and thereby determine, based on the measured current and based on the voltages applied to the driving transistor during the measurement, a threshold voltage of the driving transistor or a shift thereof. In some embodiments the monitoring system 112 extracts information regarding the current biasing elements via data lines 122a, 122b or the reference/monitor line 160 and in some embodiments this is performed in cooperation with or by the controller 102.

The monitoring system 112 can also extract an operating voltage of the light emitting device (e.g., a voltage drop across the light emitting device while the light emitting device is operating to emit light). The monitoring system 112 can then communicate signals 132 to the controller 102 and/or the memory 106 to allow the display system 150 to store the extracted aging information in the memory 106. During subsequent programming and/or emission operations of the pixel 110a, the aging information is retrieved from the memory 106 by the controller 102 via memory signals 136, and the controller 102 then compensates for the extracted degradation information in subsequent programming and/or emission operations of the pixel 110a. For example, once the degradation information is extracted, the programming information conveyed to the pixel 110a via the data line 122a can be appropriately adjusted during a subsequent programming operation of the pixel 110a such that the pixel 110a emits light with a desired amount of luminance that is independent of the degradation of the pixel 110a. In an example, an increase in the threshold voltage of the driving transistor within the pixel 110a can be compensated for by appropriately increasing the programming voltage applied to the pixel 110a. In a similar manner, the monitoring system 112 can extract the bias current of a current biasing element 155a. The monitoring system 112 can then communicate signals 132 to the controller 102 and/or the memory 106 to allow the display system 150 to store the extracted information in the memory 106. During subsequent programming of the current biasing element 155a, the information is retrieved from the memory 106 by the controller 102 via memory signals 136, and the controller 102 then compensates for the errors in current previously measured using adjustments in subsequent programming of the current biasing element 155a.

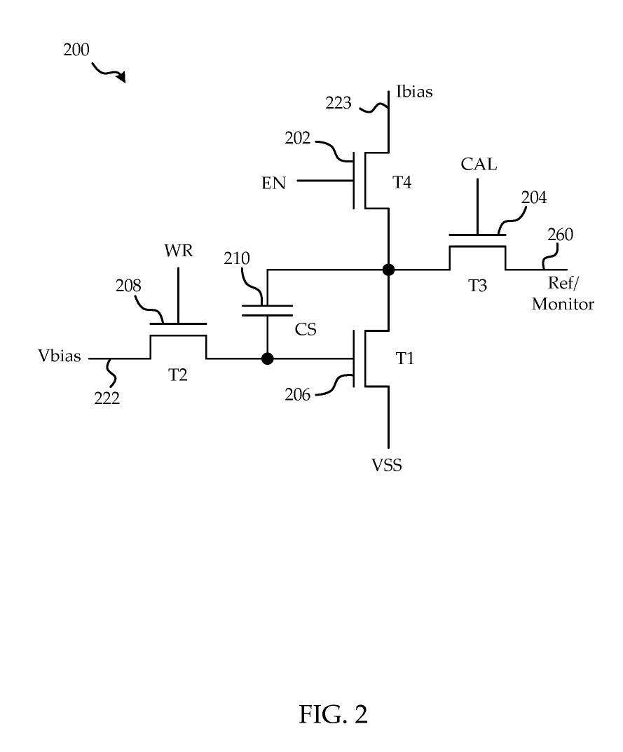

Referring to FIG. 2, the structure of a current sink 200 circuit according to an embodiment will now be described. The current sink 200 corresponds, for example, to a single current biasing element 155a, 155b of the display system 150 depicted in FIG. 1 which provides a bias current Ibias over current bias lines 123a, 123b to a CBVP pixel 110a, 110b. The current sink 200 depicted in FIG. 2 is based on PMOS transistors. A PMOS based current source is also contemplated, structured and functioning according to similar principles described here. It should be understood that variations of this current sink and its functioning are contemplated and include different types of transistors (PMOS, NMOS, or CMOS) and different semiconductor materials (e.g., LTPS, Metal Oxide, etc.).

The current sink 200 includes a first switch transistor 202 (T4) controlled by an enable signal EN coupled to its gate terminal, and being coupled via one of a source and drain terminal to a current bias line 223 (Ibias) corresponding to, for example, a current bias line 123a of FIG. 1, and coupled via the other of the source and drain terminals of the first switch transistor 202 to a first terminal of a storage capacitance 210. A gate terminal of a current drive transistor 206 (T1) is coupled to a second terminal of the storage capacitance 210, while one of the source and gate terminals of the current drive transistor 206 is coupled to the first terminal of the storage capacitance 210. The other of the source and gate terminals of the current drive transistor 206 is coupled to VSS. A gate terminal of a second switch transistor 208 (T2) is coupled to a write signal line (WR), while one of its source and drain terminals is coupled to a voltage bias or data line (Vbias) 222, corresponding, for example, to data line 122a depicted in FIG. 1. The other of the source and drain terminals of the second switch transistor 208 is coupled to the second terminal of the storage capacitance 210. A gate terminal of a third switch transistor 204 (T3) is coupled to a calibration control line (CAL), while one of its source and drain terminals is coupled to a reference monitor line 260, corresponding, for example, to reference monitor line 160 depicted in FIG. 1. The other of the source and drain terminals of the third switch transistor 204 is coupled to the first terminal of the storage capacitance 210. As mentioned above the data lines are shared, being used for providing voltage biasing or data for the pixels during certain time periods during a frame and being used for providing voltage biasing for the current biasing element, here a current sink, during other time periods of a frame. This re-use of the data lines allows for the added benefits of programming and compensation of the numerous individual current sinks using only one extra reference monitoring line 160.

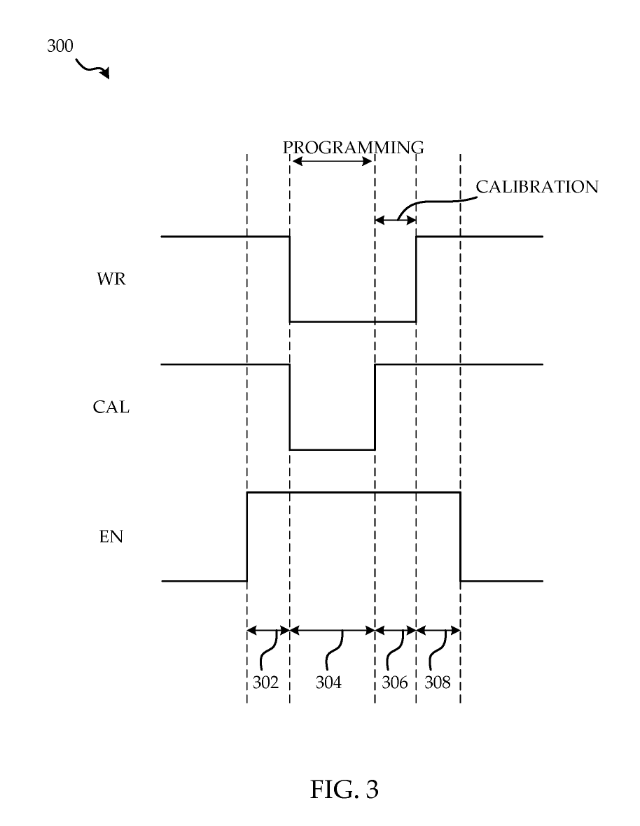

With reference also to FIG. 3, an example of a timing of a current control cycle 300 for programming and calibrating the current sink 200 depicted in FIG. 2 will now be described. The complete control cycle 300 occurs typically once per frame and includes four smaller cycles, a disconnect cycle 302, a programming cycle 304, a calibration cycle 306, and a settling cycle 308. During the disconnect cycle 302, the current sink 200 ceases to provide biasing current Ibias to the current bias line 223 in response to the EN signal going high and the first transistor switch 202 turning off. By virtue of the CAL and WR signals being high, both the second and third switch transistors 208, 204 remain off. The duration of the disconnect cycle 302 also provides a settling time for the current sink 200 circuit. The EN signal remains high throughout the entire control cycle 300, only going low once the current sink 200 circuit has been programmed, calibrated, and settled and is ready to provide the bias current over the current bias line 223. Once the current sink 200 has settled after the disconnect cycle 302 has completed, the programming cycle 304 begins with the WR signal going low turning on the second switch transistor 208 and with the CAL signal going low turning on the third switch transistor 204. During the programming cycle 304 therefore, the third switch transistor 204 connects the reference monitor line 260 over which there is transmitted a known reference signal (can be voltage or current) to the first terminal of the storage capacitance 210, while the second switch transistor 208 connects the voltage bias or data line 222 being input with voltage Vbias to the gate terminal of the current driving transistor 206 and the second terminal of the storage capacitance 210. As a result, the storage capacitance 210 is charged to a defined value. This value is roughly that which is anticipated as necessary to control the current driving transistor 206 to deliver the appropriate current biasing Ibias taking into account optional calibration described below.

After the programming cycle 304 and during the calibration cycle 306, the circuit is reconfigured to discharge some of the voltage (charge) of the storage capacitance 210 though the current driving transistor 206. The calibration signal CAL goes high, turning off the third switch transistor 204 and disconnecting the first terminal of the storage capacitance 210 from the reference monitor line 260. The amount discharged is a function of the main element of the current sink 200, namely the current driving transistor 206 or its related components. For example, if the current driving transistor 206 is “strong”, the discharge occurs relatively quickly and relatively more charge is discharged from the storage capacitance 210 through the current driving transistor 206 during the fixed duration of the calibration cycle 306. On the other hand, if the current driving transistor 206 is “weak,” the discharge occurs relatively slowly and relatively less charge is discharged from the storage capacitance 210 through the current driving transistor 206 during the fixed duration of the calibration cycle 306. As a result the voltage (charge) stored in the storage capacitance 210 is reduced comparatively more for relatively strong current driving transistors versus comparatively less for relatively weak current driving transistors thereby providing some compensation for non-uniformity and variations in current driving transistors across the display whether due to variations in fabrication or variations in degradation over time.

After the calibration cycle 306, a settling cycle 308 is performed prior to provision of the biasing current Ibias to the current bias line 223. During the settling cycle 308, the first and third switch transistors 202, 204 remain off while the WR signal goes high to also turn the second switch transistor 208 off. After completion of the duration of the settling cycle 308, the enable signal EN goes low turning on the first switch transistor 202 and allowing the current driving transistor 206 to sink the Ibias current on the current bias line 223 according to the voltage (charge) stored in the storage capacitance 210, which as mentioned above, has a value which has been drained as a function of the current driving transistor 206 in order to provide compensation for the specific characteristics of the current driving transistor 206.

In some embodiments, the calibration cycle 306 is eliminated. In such a case, the compensation manifested as a change in the voltage (charge) stored by the storage capacitance 210 as a function of the characteristics of the current driving transistor 206 is not automatically provided. In such a case a form of manual compensation may be utilized in combination with monitoring.

In some embodiments, after a current sink 200 has been programmed, and prior to providing the biasing current over the current bias line 223, the current of the current sink 200 is measured through the reference monitor line 260 by controlling the CAL signal to go low, turning on the third switch transistor 204. As illustrated in FIG. 1, in some embodiments the reference monitor line 160 is shared and hence during measurement of the current sink 200 of interest all other current sinks are programmed or otherwise controlled such that they do not source or sink any current on the reference monitor line 160. Once the current of the current sink 200 has been measured in response to known programming of the current sink 200 and possibly after a number of various current measurements in response to various programming values have been measured and stored in memory 106, the controller 102 and memory 106 (possibly in cooperation with other components of the display system 150) adjusts the voltage Vbias used to program the current sink 200 to compensate for the deviations from the expected or desired current sinking exhibited by the current sink 200. This monitoring and compensation, need not be performed every frame and can be performed in a periodic manner over the lifetime of the display to correct for degradation of the current sink 200.

In some embodiments a combination of calibration and monitoring and compensation is used. In such a case the calibration can occur every frame in combination with periodic monitoring and compensation.

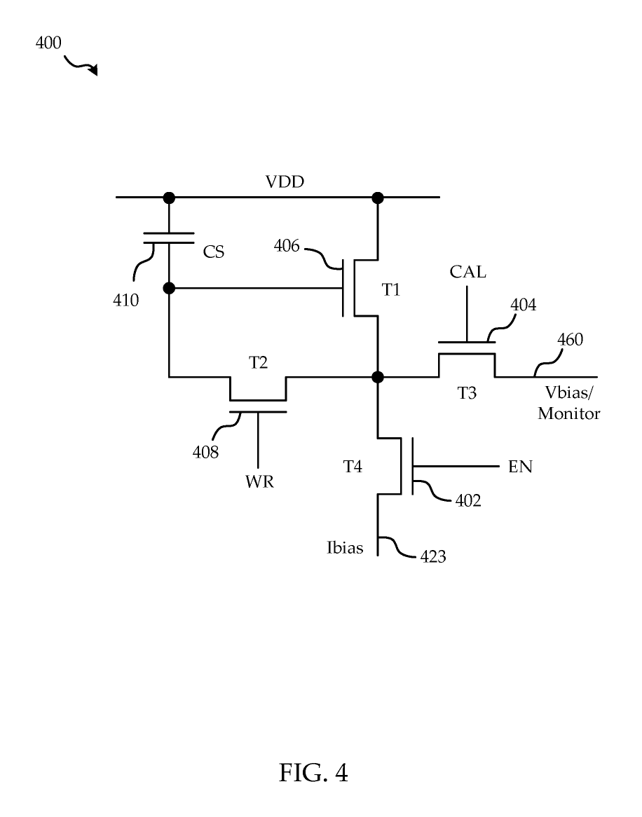

Referring to FIG. 4, the structure of a current source 400 circuit according to an embodiment will now be described. The current source 400 corresponds, for example, to a single current biasing element 155a, 155b of the display system 150 depicted in FIG. 1 which provides a bias current Ibias over current bias lines 123a, 123b to a CBVP pixel 110a, 110b. As is described in more detail below, the connections and manner of integration of current source 400 into the display system 150 is slightly different from that depicted in FIG. 1 for a current sink 200. The current source 400 depicted in FIG. 4 is based on PMOS transistors. It should be understood that variations of this current source and its functioning are contemplated and include different types of transistors (PMOS, NMOS, or CMOS) and different semiconductor materials (e.g. LTPS, Metal Oxide, etc.).

The current source 400 includes a first switch transistor 402 (T4) controlled by an enable signal EN coupled to its gate terminal, and being coupled via one of a source and drain terminal of the first transistor switch 405 to a current bias line 423 (Ibias) corresponding to, for example, a current bias line 123a of FIG. 1. A gate terminal of a current drive transistor 406 (T1) is coupled to a first terminal of a storage capacitance 410, while a first of the source and drain terminals of the current drive transistor 406 is coupled to the other of the source and drain terminals of the first switch transistor 402, and a second of the source and drain terminals of the current drive transistor 406 is coupled to a second terminal of the storage capacitance 410. The second terminal of the storage capacitance 410 is coupled to VDD. A gate terminal of a second switch transistor 408 (T2) is coupled to a write signal line (WR), while one of its source and drain terminals is coupled to the first terminal of the storage capacitance 410 and the other of its source and drain terminals is coupled to the first of the source and drain terminals of the current driving transistor 406. A gate terminal of a third switch transistor 404 (T3) is coupled to a calibration control line (CAL), while one of its source and drain terminals is coupled to a voltage bias monitor line 460, corresponding, for example, to voltage bias or data lines 122a, 122b depicted in FIG. 1. The other of the source and drain terminals of the third switch transistor 404 is coupled to the first of the source and drain terminals of the current drive transistor 406.

In the embodiment depicted in FIG. 4, the current source is not coupled to a reference monitor line 160 such as that depicted in FIG. 1. Instead of the current source 400 being programmed with Vbias and a reference voltage as in the case of the current sink 200, the storage capacitance 410 of the current source 400 is programmed to a defined value using the voltage bias signal Vbias provided over the voltage bias or data line 122a and VDD. In this embodiment the data lines 122a, 122b serve as monitor lines as and when needed.

Referring once again to FIG. 3, an example of a timing of a current control cycle 300 for programming and calibrating the current source 400 depicted in FIG. 4 will now be described. The timing of the current control cycle 300 for programming the current source 400 of FIG. 4 is the same as that for the current sink 200 of FIG. 2.

The complete control cycle 300 occurs typically once per frame and includes four smaller cycles, a disconnect cycle 302, a programming cycle 304, a calibration cycle 306, and a settling cycle 308. During the disconnect cycle 302, the current source 400 ceases to provide biasing current Ibias to the current bias line 423 in response to the EN signal going high and the first transistor switch 402 turning off. By virtue of the CAL and WR signals being high, both the second and third switch transistors 408, 404 remain off. The duration of the disconnect cycle 402 also provides a settling time for the current source 400 circuit. The EN signal remains high throughout the entire control cycle 300, only going low once the current source 400 circuit has been programmed, calibrated, and settled and is ready to provide the bias current over the current bias line 423. Once the current source 400 has settled after the disconnect cycle 302 has completed, the programming cycle 304 begins with the WR signal going low turning on the second switch transistor 408 and with the CAL signal going low turning on the third switch transistor 404. During the programming cycle 304 therefore, the third switch transistor 404 and the second switch transistor 408 connects the voltage bias monitor line 460 over which there is transmitted a known Vbias signal to the first terminal of the storage capacitance 410. As a result, since the second terminal of the storage capacitance 410 is coupled top VDD, the storage capacitance 410 is charged to a defined value. This value is roughly that which is anticipated as necessary to control the current driving transistor 406 to deliver the appropriate current biasing Ibias taking into account optional calibration described below.

After the programming cycle 304 and during the calibration cycle 306, the circuit is reconfigured to discharge some of the voltage (charge) of the storage capacitance 410 though the current driving transistor 406. The calibration signal CAL goes high, turning off the third switch transistor 404 and disconnecting the first terminal of the storage capacitance 410 from the voltage bias monitor line 460. The amount discharged is a function of the main element of the current source 400, namely the current driving transistor 406 or its related components. For example, if the current driving transistor 406 is “strong”, the discharge occurs relatively quickly and relatively more charge is discharged from the storage capacitance 410 through the current driving transistor 406 during the fixed duration of the calibration cycle 306. On the other hand, if the current driving transistor 406 is “weak,” the discharge occurs relatively slowly and relatively less charge is discharged from the storage capacitance 410 through the current driving transistor 406 during the fixed duration of the calibration cycle 306. As a result the voltage (charge) stored in the storage capacitance 410 is reduced comparatively more for relatively strong current driving transistors versus comparatively less for relatively weak current driving transistors thereby providing some compensation for non-uniformity and variations in current driving transistors across the display whether due to variations in fabrication or degradation over time.

After the calibration cycle 306, a settling cycle 308 is performed prior to provision of the biasing current Ibias to the current bias line 423. During the settling cycle, the first and third switch transistors 402, 404 remain off while the WR signal goes high to also turn the second switch transistor 408 off. After completion of the duration of the settling cycle 308, the enable signal EN goes low turning on the first switch transistor 402 and allowing the current driving transistor 406 to source the Ibias current on the current bias line 423 according to the voltage (charge) stored in the storage capacitance 410, which as mentioned above, has a value which has been drained as a function of the current driving transistor 406 in order to provide compensation for the specific characteristics of the current driving transistor 406.

In some embodiments, the calibration cycle 306 is eliminated. In such a case, the compensation manifested as a change in the voltage (charge) stored by the storage capacitance 410 as a function of the characteristics of the current driving transistor 406 is not automatically provided. In such a case, as with the embodiment above in the context of a current sink 200 a form of manual compensation may be utilized in combination with monitoring for the current source 400.

In some embodiments, after a current source 400 has been programmed, and prior to providing the biasing current over the current bias line 423, the current of the current source 400 is measured through the voltage bias monitor line 460 by controlling the CAL signal to go low, turning on the third switch transistor 404.

Once the current of the current source 400 has been measured in response to known programming of the current source 400 and possibly after a number of various current measurements in response to various programming values have been measured and stored in memory 106, the controller 102 and memory 106 (possibly in cooperation with other components of the display system 150) adjusts the voltage Vbias used to program the current source 400 to compensate for the deviations from the expected or desired current sourcing exhibited by the current source 400. This monitoring and compensation, need not be performed every frame and can be performed in a periodic manner over the lifetime of the display to correct for degradation of the current source 400.

Although the current sink 200 of FIG. 2 and the current source 400 of FIG. 4 have each been depicted as possessing a single current driving transistor 206, 406 it should be understood that each may comprise a cascaded transistor structure for providing the same functionality as shown and described in association with FIG. 2 and FIG. 4.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A system for providing biasing currents to pixels of an emissive display system, each pixel having a light-emitting device, the system comprising:
a plurality of current biasing elements;
a plurality of current bias lines coupling said plurality of current biasing elements to said pixels; and
a controller coupled to said current biasing elements for controlling a programming of said current biasing elements over a plurality of signal lines;
wherein each current biasing element comprises:
at least one current driving transistor coupled to a current bias line for providing a biasing current over the current bias line; and
a storage capacitance for being programmed and for setting a magnitude of the biasing current provided by the at least one current driving transistor;
wherein the controller's controlling the programming of each current biasing element comprises:
during a programming cycle charging the storage capacitance to a defined level; and
subsequent to the programming cycle, during a calibration cycle, partially discharging the storage capacitance as a function of characteristics of the at least one driving transistor.

2. The system of claim 1, wherein the plurality of signal lines comprises a plurality of data lines coupling a source driver of the emissive display system to the pixels and for programming said pixels, the data lines for coupling the controller and the plurality of current biasing elements at times different from when the data lines couple the source driver to the pixels.

3. The system of claim 2, further comprising a reference monitor line shared by the plurality of current biasing elements and coupling the plurality of current biasing elements to the controller.

4. The system of claim 2 wherein each current biasing element is a current sink, wherein the at least one current driving transistor comprises a single current driving transistor, wherein the storage capacitance is coupled across a gate of said current driving transistor and one of a source and drain of said current driving transistor, the other of said source and drain of said current driving transistor coupled to a voltage supply, wherein during the calibration cycle, the current driving transistor is allowed to partially discharge said storage capacitance through the current driving transistor to said voltage supply.

5. The system of claim 2 wherein each current biasing element is a current source, wherein the at least one current driving transistor comprises a single current driving transistor, wherein the storage capacitance is coupled across a gate of said current driving transistor and one of a source and drain of said current driving transistor, the one of said source and drain of said current driving transistor coupled to a voltage supply, wherein during the calibration cycle, the current driving transistor is allowed to partially discharge said storage capacitance through the current driving transistor to said voltage supply.

6. A system for providing biasing currents to pixels of an emissive display system, each pixel having a light-emitting device, the system comprising:
a plurality of current biasing elements;
a plurality of current bias lines coupling said plurality of current biasing elements to said pixels;
a controller coupled to said current biasing elements for controlling a programming of said current biasing elements over a plurality of signal lines; and
a monitor coupled to the plurality of current biasing elements for monitoring a biasing current produced by each current biasing element and for storing in a memory a measurement representing said biasing current for each current biasing element;
wherein each current biasing element comprises:
at least one current driving transistor coupled to a current bias line for providing a biasing current over the current bias line; and
a storage capacitance for being programmed and for setting a magnitude of the biasing current provided by the at least one current driving transistor;
wherein the controller's controlling the programming of each current biasing element comprises:
retrieving from said memory said measurement representing said biasing current for the current biasing element;
determining a deviation of said biasing current represented by said measurement from an expected biasing current; and
charging the storage capacitance to a defined compensated level which compensates for said deviation so that said current biasing element produces the expected biasing current.

7. The system of claim 6, wherein the plurality of signal lines comprises a plurality of data lines coupling a source driver of the emissive display system to the pixels and for programming said pixels, the data lines for coupling the controller and the plurality of current biasing elements at times different from when the data lines couple the source driver to the pixels.

8. The system of claim 6, further comprising a reference monitor line shared by the plurality of current biasing elements and coupling the plurality of current biasing elements to the controller, the controller coupled to the monitor.

9. A method of providing biasing currents to pixels of an emissive display system, each pixel having a light-emitting device, the emissive display system including a plurality of current biasing elements and a plurality of current bias lines coupling said plurality of current biasing elements to said pixels, each current biasing element including at least one current driving transistor coupled to a current bias line for providing a biasing current over the current bias line and a storage capacitance for being programmed and for setting a magnitude of the biasing current provided by the at least one current driving transistor, the method comprising:
programming each current biasing element over a plurality of signal lines comprising:
charging the storage capacitance to a defined level during a programming cycle; and
subsequent to the programming cycle, during a calibration cycle, partially discharging the storage capacitance as a function of characteristics of the at least one driving transistor.

10. The method of claim 9, wherein the plurality of signal lines comprises a plurality of data lines coupling a source driver of the emissive display system to the pixels and for programming said pixels, the data lines for coupling the controller and the plurality of current biasing elements for performing said programming each current biasing element at times different from when the data lines couple the source driver to the pixels.

11. The method of claim 10, wherein a reference monitor line is shared by the plurality of current biasing elements and wherein said charging said storage capacitance comprises coupling to the controller over said reference monitor line each current biasing element being charged while de-coupling from the controller current biasing elements not being charged.

12. The method of claim 10 wherein each current biasing element is a current sink, wherein the at least one current driving transistor comprises a single current driving transistor, wherein the storage capacitance is coupled across a gate of said current driving transistor and one of a source and drain of said current driving transistor, the other of said source and drain of said current driving transistor coupled to a voltage supply, wherein during the calibration cycle, partially discharging the storage capacitance comprises allowing the current driving transistor to partially discharge said storage capacitance through the current driving transistor to said voltage supply.

13. The method of claim 10 wherein each current biasing element is a current source, wherein the at least one current driving transistor comprises a single current driving transistor, wherein the storage capacitance is coupled across a gate of said current driving transistor and one of a source and drain of said current driving transistor, the one of said source and drain of said current driving transistor coupled to a voltage supply, wherein during the calibration cycle, partially discharging the storage capacitance comprises allowing the current driving transistor to partially discharge said storage capacitance through the current driving transistor to said voltage supply.

14. A method of providing biasing currents to pixels of an emissive display system, each pixel having a light-emitting device, the emissive display system including a plurality of current biasing elements, a plurality of current bias lines coupling said plurality of current biasing elements to said pixels, each current biasing element including at least one current driving transistor coupled to a current bias line for providing a biasing current over the current bias line and a storage capacitance for being programmed and for setting a magnitude of the biasing current provided by the at least one current driving transistor, the method comprising:
monitoring a biasing current produced by each current biasing element;
storing in a memory a measurement representing said biasing current for each current biasing element; and
programming each current biasing element over a plurality of signal lines comprising:
retrieving from said memory said measurement representing said biasing current for the current biasing element;
determining a deviation of said biasing current represented by said measurement from an expected biasing current; and
charging the storage capacitance to a defined compensated level which compensates for said deviation so that said current biasing element produces the expected biasing current.

15. The method of claim 14, wherein the plurality of signal lines comprises a plurality of data lines coupling a source driver of the emissive display system to the pixels and for programming said pixels, the data lines for coupling the controller and the plurality of current biasing elements for performing said programming each current biasing element at times different from when the data lines couple the source driver to the pixels.

16. The method of claim 14, wherein the controller is coupled to the monitor, a reference monitor line is shared by the plurality of current biasing elements and wherein said monitoring each current biasing element comprises coupling to the controller over the reference monitor line each current biasing element being measured while de-coupling from the controller current biasing elements not being measured.
